(19) United States
(12) Patent Application Publication
(10) Pub. No.: US 2013/0303988 A1
(43) Pub. Date: Nov. 14, 2013

(54) System for Oral Delivery of an Agent to an Animal

(71) Applicant: Grant Andrew Weyer, Mount Crosby (AU)

(72) Inventor: Grant Andrew Weyer, Mount Crosby (AU)

(73) Assignee: SMARTVET PTY LTD., Fig Tree Pocket (AU)

(21) Appl. No.: 13/822,921

(22) PCT Filed: Sep. 12, 2011
(86) PCT No.: PCT/AU11/01173

§ 371 Date: Apr. 29, 2013

Related U.S. Application Data
(60) Provisional application No. 61/382,251, filed on Sep. 13, 2010.

(51) Int. Cl. A61D 7/00

(52) U.S. Cl. CPC A61D 7/00
USPC 604/130

(57) ABSTRACT

An oral delivery system for remotely treating an animal comprising an edible dosage projectile containing an active agent, wherein the projectile is capable of being remotely delivered over a distance. A method for administering an active agent to an animal using the system.

### TECHNICAL FIELD

The present invention relates to an oral delivery system for remotely treating an animal with an active agent.

### BACKGROUND

In practice, it is frequently difficult and costly to deliver medicinal compounds to animals, especially if such animals are not kept in enclosures or specifically herded and contained for that purpose.

One application of the technology is in transmissible disease control programs throughout the world where free ranging, wild or feral animal populations are targeted for treatment so as to contain and reduce transmission of infectious diseases. In situations of outbreak of disease in wild animals, it is often necessary to dart diseased animals in order to deliver the required medicinal compounds to the animals. This method of disease control and prevention has limited success and is particularly stressful for the animals. It is also difficult to determine which animals have been darted, and which animals still need to be treated. In addition, using traditional systems, it is only possible to dart an animal with a single dose of a medicament—if more than one type of medicament is to be administered, the animal needs to be darted or injected more than once, or they need to be tranquilized individually, and then injected with the required medicaments.

The problem of treating free ranging animals, particularly wild animals, has often been carried out in the past by development of delivery devices, such as darts, and the like, that must pierce or penetrate the skin or tissue of the animal. Although these devices can effectively deliver the desired treatment, often the animal is exposed to the potential of post-treatment infections at the site of delivery. An additional problem with many of the prior art methods is that it can be difficult to determine or monitor which animal has been treated.

Other methods for remotely delivering agents to animals or humans can involve providing of aerosols in close proximity to the animal to be treated from a projectile that does not penetrate the skin or tissue. An example of this form of delivery can be found in US 2002/0129728 in the name of Jaycor Tactical Systems. Although this system is particularly suitable for personnel or crowd control, it cannot deliver a defined dosage of a biologically active agent as a treatment regime to an animal. The dosage is variable and would depend on how much ‘dust or powder’ is taken up in the lungs.

WO 2005/074672 in the name of Simon Robert Trickey describes a frangible missile containing a treating substance that can be applied to the surface of an animal. Unfortunately, this system has very limited application as it can only provide treatment to the surface of the skin. Most veterinary medicines and chemicals, however, do not act directly on the surface of the skin so this system does not solve the problem of providing an effective remote delivery system for animals.

A number of prior art treatment systems require delivery of an agent by piercing the skin or tissue. Examples in this regard include U.S. Pat. No. 6,419,655 in the name of Gonex Inc, U.S. Pat. No. 6,584,910 in the name of David Plass, WO 00/71967 and US 2004/0089186 in the name of Richard Brydges-Price. Each of these systems can cause injury to an animal and are susceptable to causing post treatment infection at the site of impact.

The present applicant has previously developed a system for delivering a biological agent through the skin of an animal as set out in WO 2008/052263. This system, however, is not suitable for oral delivery of active agents to animals as the projectile is not capable of being delivered to the general environment nor formulated for oral delivery.

Another means for treating animals is to physically place baits and the like in the wild and hope that animals will find and consume the baits. This process can be labour intensive and often areas cannot be entered due to watery or rugged terrain so that it is not possible to add baits to many areas of highly suitable habitat that are used regularly by the targeted species.

The present inventor has developed a system that allows the remote delivery of orally active agents to an animal.

### SUMMARY OF INVENTION

In a first aspect, the present invention provides an oral delivery system for remotely treating an animal comprising:

an edible dosage projectile containing an active agent,

wherein the projectile is capable of being remotely delivered over a distance.

The projectile further may further include an attractant.

The projectile further may further include a tag or marker.

The projectile further may further include a repellent.

The projectile further may further include food material.

Preferably, the projectile comprises a shell and the active agent is housed within the shell of the projectile.

The system may be used to deliver an active agent to an animal to treat or prevent an infectious disease, parasite infestation or condition, dietary deficiency, or fertility.

The system may be used to deliver an active agent to kill, incapacitate or sterilize an animal.

The active agent can be present at a concentration (% v/v) of from about 0.1% to 99%. Preferably, the active agent is at a concentration (% v/v) up to 0.5%, 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 75, 80%, 85%, 90%, or 95%. The active agent may be at a concentration (% v/v) of from 0.5% to 10%. Preferably, the active agent is at a concentration (% v/v) of from 1% to 5%. It will be appreciated that the concentration of the active agent will be related to the dosage required for a particular size of animal.

In one preferred form, the active agent is an oral veterinary pharmacological agent.

In another preferred form, the active agent is an oral contraceptive.

In another preferred form, the active agent is an hormone.

In another preferred form, the active agent is a health supplement such as a vitamin or mineral. Examples of suitable vitamins or minerals include, but not limited to, calcium, potassium, iron, thiamine and Vitamin B12.

In another preferred form, the active agent is an oral vaccine or immunogenic compound or composition. In this preferred form, the composition may include one or more adjuvants to assist in the efficacy of the vaccine. Suitable adjuvants would be readily known to a person skilled in the art. It will be appreciated that the adjuvant may also act as a transdermal carrier to assist in the movement of the active agent.

In another preferred form, the active agent is a poison or toxin capable of killing the animal.

The active agent may be formulated in any suitable solvent or liquid or powder carrier.

The projectile is adapted to deliver the active agent to the environment where the animal can find it and consume the contents.

The projectile containing an active agent is preferably in the form of a capsule or pellet produced in circular or spherical form measuring anywhere from 2 mm to 50 mm. Preferably, the projectile is has a volume of 10 ml.

The shell of the projectile may be made of any suitable encapsulating material, such as, for example, gelatine, linear polymers, or polystyrene derivatives, thin-walled plastics materials, hydrophilic colloidal materials such as, gelatin, silicon dioxide, albumin, gum arabic, alginate, casein, agar or pectins, or combinations thereof, or synthetic organic compounds such as, but not limited to, polystyrene, polypropylene, polyethylene, polycarbonate, polyamide, polysulfane, polyvinylchloride, resinous compounds such as fibreglass or Perspex derivatives, or combinations thereof.

Preferably, the shell of the projectile is made of soft gelatine, glycerol and/or sorbitol and combinations thereof.

The active agent and optional other contents may be encapsulated in one or more encapsulating or coating agents in order to more effectively control the delivery rate of the active agent to the animal when consumed. The encapsulating or coating agent may be chosen such that it regulates the release of the active agent once it has been consumed by the animal. The contents of the capsule may likewise be microencapsulated within the shell to regulate release of the agent or protect the agent from release until it is located in a defined physiological area or at a defined time.

Preferably, the projectile is remotely delivered by a launcher. Typically, the projectile is shot from a launching device such as a gun, pressure or gas activated launcher or the like. Examples of potentially suitable launching devices may be based on similar gas discharge technologies utilized in current dart guns, air guns, crowd control guns and paintball markers currently in production and used in the veterinary, security, law enforcement, hunting, and recreational shooting or paintball industry.

The projectiles may be launched with a single trigger action from a projectile launcher. The projectile launcher may include a selector for selecting the number of projectiles to be launched with a single trigger action. Alternatively, the projectiles may be delivered using a semi-automatic trigger action.

The projectiles, when used to deliver multiple active agents or doses, may include active agents which are similar or differing in composition, efficacy, or pharmaceutical action. Accordingly, it is to be understood that the dose administered to an animal may be controlled by selecting the number and type of dosage forms or projectiles to be launched at an animal. In this way, a user can easily adjust the dose required for correctly dosing the animal, by compensating for the size and weight of an animal, and tailor dosing regimens.

The projectile launcher may include velocity selection means operable to select the velocity at which the projectile is launched. For example the velocity selection means may include pressure-regulating means operable to select the pressure at which the pressurized fluid is released.

The launching propellant may be a pressurized fluid, such as gas or air.

In a second aspect, the present invention provides a method for administering an active agent to an animal comprising:

providing an oral delivery system according to the first aspect of present invention to an animal by remote delivery; and

allowing an animal to consume the projectile to administer the active agent.

Target animals include wild, domestic, domesticated, farm or feral animals. Examples include, but not limited to, rats, mice, raccoons, badgers, deer, antelope, horses, buffalo, geese, pigeons, ducks, fish, dogs, cats, foxes, possums, coyotes, kangaroos, rabbits, bison, pigs, hippopotamus or elephant.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention before the priority date of each claim of this specification.

In order that the present invention may be more clearly understood, preferred embodiments will be described with reference to the following examples.

### MODE(S) FOR CARRYING OUT THE INVENTION

### Definitions

‘Active agent’ includes an active compound or compounds of any suitable kind such as biologically active agent, oral vaccine, veterinary pharmaceutical, veterinary pharmacological, hormone, vitamin, mineral, health supplement, poison, toxin, killing agent or any combination thereof.

‘Treatment of an animal’ as used herein includes providing health benefits to an animal, sterilization or controlling fertility of an animal, or killing an undesired animal through oral administration of an active agent.

‘Remote delivery’ as used herein relates to firing or launching the projectile over a distance to a location where an animal can consume the projectile or its contents.

### Aspects

A launcher can be used to distribute a capsule or pellet that contains or is impregnated with an active agent on land or water. The distributed capsules are intended to be found and eaten by animals thereby orally administering an active ingredient such as vaccine, veterinary pharmaceutical, hormone, health supplement or vitamin and mineral, or poison.

The launcher to be used is similar to the launcher suitable for WO 2008/052263 and is a gas powered device that can fire multiple salvos of capsules to a distance anywhere between 1 and 1000 metres.

The invention provides a projectile containing an active agent, preferably in the form of a capsule or pellet produced in circular or spherical form measuring anywhere from 2 mm to 50 mm, that is designed to be capable of discharge from a launcher. The capsules are dispersed using a launcher either alone or together with other non medicated edible capsules (to attract the target animals). The capsule or pellets may take on one of the following forms:

Gelcoat capsule: in this form the capsule contains one or a combination of the active ingredients and is dispersed with other non-medicated capsules and designed to be found and eaten by an animal.

Impregnated capsule: in this form the capsule contains a gelcoat or shell that is impregnated or treated with an attractant such as a smell or taste that results in the target animal locating and consuming the capsule with greater efficiency. This capsule would also contain one or a combination of the active ingredients.

Divided capsule: in this form the capsule is divided so as to contain two separate compartments with each separate compartment containing an active ingredient or combination thereof.

Capsule in a capsule: in this format a larger capsule contains one or any number of smaller capsules. In one such design iteration the larger capsule may be designed to break and release an attractant while all or some of the internal capsules remain intact to administer one or a number of active ingredients.

Microencapsulated capsules: in this format microencapsulated capsules contain the active ingredient. In one design iteration, the microencapsulated formulation can then be mixed in with a food or attractant mixture to form entire round pellets not dissimilar to a dog food pellet. The microencapsulated formulation then releases the active ingredients at a prescribed time after ingestion, in order to deliver a dose to the targeted animals. In another permutation, the microencapsulated formulation containing the active ingredients can be included in any one of the other capsule types suitable for the present invention.

Coated pellet: in this iteration a capsule or shell containing the active ingredient is coated in hard or semi hard mixture of attractant or covering to form a pellet of ballistically efficient design with an intact capsule hidden within.

In another distinct format the capsule could also contain a deterrent in the form of a scent, chemical mixture, urine, faecal extracts or hormones that would have the effect of keeping animals away from a certain area.

### Projectile Materials or Coatings

Any edible substance that can be used to encapsulate a formulation or to coat a capsule by being compressed around, mixed in or impregnated into one of the capsule forms to aid with detection, location and ingestion of the capsule. These include sugars, oils such as fish oil, protein extracts, gland extracts, fish meal, bone meal, food flavourings, flavoured gelatine, fats, food scents, food colorants and other additives, plant and fruit extracts, concentrated vegetable or fruit mixes such as jam, sugars, molasses, gels from fruit vegetables fats, processed body parts such as the intestine, testes, any chemical or compound, part or extract from any part of an animal, egg, plant, fruit or flower that has the effect of gaining the interest of an animal.

### Active Agents

### Vaccines

Any vaccine that can be administered orally that prevents disease by creating antibodies or a cell mediated response to neutralise the causative virus, bacteria or toxin. The part of the vaccine that trains the immune system into making the appropriate antibodies is called an antigen. Antigens can be introduced by:

Modified Live Vaccines: modified live vaccines contain an attenuated or weakened infectious agent. These vaccines create a mild form of the disease that stimulates a natural immune response.

Killed Vaccines: Killed vaccines contain an inactivated disease-causing agent. These vaccines are designed to create antibodies without the negative effects of infection so are generally considered to be safer. However, during the inactivation process, some of the surface antigens needed to create the desired antibodies may be destroyed thus reducing their effectiveness.

Subunit Vaccines: Subunit vaccines use only the necessary parts of the virus or toxin to stimulate immunity. Unlike modified live vaccines, subunit vaccines stimulate the immune system to prevent disease without stressing the animal. Unlike killed vaccines, subunit vaccines can do a better job of disease prevention as they only contain concentrated amounts of the target antigen. These qualities make subunit vaccines both safe and effective. Dow AgroSciences plant-cell-produced vaccines are a new type of subunit vaccine.

### Examples of Suitable Vaccines

RABORAL V-RG® strategic use of this vaccine by public health officials has proven to reduce the rate of rabies infection in wildlife populations.

Inactivated Yersinia ruckeri vaccine (Hagerman strain) contained within a microencapsulated protective vehicle to protect the antigen. This is used by fish farmers.

A University of Central Florida researcher has recently successfully trialled an oral vaccine tested in rats for immunisation against the Bubonic Plague.

Bacillus Calmette-Guërin (or Bacille Calmette-Guërin, BCG) is an effective vaccine against tuberculosis that can be orally administered.

A new oral vaccine recently developed by the US Agricultural Research Service scientists may help US cattle producers cut their losses from bovine respiratory disease (BRD), commonly known as shipping fever. This disease costs the industry more than $1 billion annually.

Enterisol® lleitis. Enterisol® lleitis has been approved for the active immunization of pigs against the bacteria Lawsonia intracellularis as an aid to prevent and control porcine proliferative enteropathy.

There is an existing Brucellosis vaccine successfully tested through oral administration on feral pigs.

### Veterinary Pharmaceuticals

Preferred veterinary pharmaceuticals include any medications that can be taken orally and used for the following purposes:

Antipyretics: reducing fever (pyrexia)

Analgesics: painkillers

Antibiotics: inhibiting microorganism growth or infection

Antiseptics: prevention of germ growth near bums, cuts and wounds

Antiparasitic: prevention or treatment of internal of external parasites

The types of pharmacotherapy for which these medications can be used include:

For the gastrointestinal tract or digestive system including for the treatment of internal parasites.

For the cardiovascular system

For the central nervous system

For pain & consciousness (analgesic drugs)

For musculo-skeletal disorders

For the eye

For the ear, nose and oropharynx

For the respiratory system

For endocrine problems

For the reproductive system or urinary system

For contraception

For obstetrics and gynecology

For the skin including the treatment of external parasites

For infections and infestations

For immunology

For allergic disorders

For nutrition

For neoplastic disorders

For diagnostics

For euthanasia

Examples of suitable oral contraceptives include phosphodiesterase 3 inhibitor (for non ruminants); Ovocontrol G and Ovocontrol P (for geese and pigeons).

Non limiting examples of suitable active agents are set out below.

### Antipyretics

Dipyrone, Acetylsalicylic Acid, Acetaminophen (Parecetamol).

### Analgesics/Anti-Inflammatory Agents

NSAIDs (Non-Steroidal Anti-inflammatory Drugs), Flunixin meglumine, Meloxicam, Carprofen, Piroxicam.

### Steroids Anti-Inflammatory Drugs

Dexamethasone, Prednisolone, Flumethasone

### Antibiotics

Beta Lactams: Penicillins, Penicillin G, Ampicillin, Amoxicillin, Cephalosporins, Ceftiofur, Cefoperazone

Aminoglycosides: Streptomycin and dihydrostreptomycin, Gentamicin, Neomycin, Spectinomycin.

Polymyxins: Colistin.

Vancomycin.

Bacitracin.

Tetracyclines: Oxytetracycline, Doxycycline.

Chloramphenicol and analogs: Chloramphenicol, Florphenicol, Thiamphenicol

Macrolides and Lincosamides: Erythromycin, Azithromycin, Spiramycin, Tylosin, Lincomycin.

Rifamycins

Phosphomycin

Novobiocin

Chemotherapics: Sulfonamides and Trimethoprim, Quinolones, Metronidazole.

### Antiseptics

Surfactants such as Quaternary Ammonium, Chloride and derivatives, Aldehydes, Phenolic Compounds, Biguanidines, Iodine and derivatives, Heavy metals, Acid agents, Oxidizing agents.

### Antiparasitics

Pyrethroids: Permethrin, Cypermethrin, Deltamethrin, Flumethrin, Cyfluthrin; Carbamates: Propoxur, Carbaryl; Organophosphates: Trichlorfon, Chlorpyriphos, Fenthion, Fenitrothion, Ethion, DDVP (Dichlorvos); Formamidines: Amitraz; Macrocyclic; Lactones: Avermectins (Ivermectin, Abamectin, Doramectin, Eprinomectin, Selamectin), Milbemycins.

Others: Fipronil, Fluazuron, Diflubenzuron, Lufenzuron, Methoprene, Imidacloprid; Imidazothiazoles—Levamisole, Tetramisole; Benzimidazoles—Albendazole, Flubendazole, Oxfendazole, Mebendazole, Fenbendazole; Pyrimidines—Morantel, Pyrantel, Closantel, Rafoxanide, Disophenol, Nitroxinil, Praziquantel, Piperazines.

Drugs against blood-borne organisms: Diminazene, Imidocarb.

Anticoccidials: Ionophores (Monensin), Nitrofurans, Decoquinate, Halofuginone, Amprolium, Nicarbazin.

### Hormones

Beta agonists, Oxytocin, Ergonovine, Methylergonovine, Somatotropin, Estrogens, GnRH, LH, FSH, Prolactin, Progesterone, Medroxyprogesterone Acetate (MAP), Melengestrol Acetate (MGA), Norgestomet, Proligestone.

Prostaglandins: Chloprostenol, Dinoprost tromethamine, Fluprostenol.

### Killing Agents

Suitable agents include acute poisons such as Sodium monofluoroacetate (“1080”), Cyanide (Feratox®), Cholecalciferol (Campaign®, Feracol®).

Suitable agents include anticoagulant poisons such as Brodifacoum (Talon®, Pestoff®), Flocoumafen (Storm®). Bromadiolone, Coumateralyl, Diphacinone, Pindone, Warfarin.

Other poison agents include Phorsphorus, Arsenic, Strychnine.

### Animal Attractants

Any edible substance that can be used to coat or cover a capsule by being compressed around, mixed in or impregnated into one of the capsule forms to aid with detection, location and ingestion of the capsule. These include sugars, oils such as fish oil, protein extracts, gland extracts, fish meal, bone meal, food flavourings, flavoured gelatine, fats, food scents, food colorants and other additives, plant and fruit extracts, concentrated vegetable or fruit mixes such as jam, sugars, molasses, gels from fruit vegetables fats, processed body parts such as the intestine, testes, any chemical or compound, part or extract from any part of an animal, egg, plant, fruit or flower that has the effect of gaining the interest of an animal.

### Animal Repellents

Chemicals suitable to minimize risk of attraction or ingestion by non-target animals include ammonia or chemical mixtures, chilli or capsicum derivatives such as capsaicin (8-methyl-N-vaniliyl-6-nonenamide), chemicals such as lachrymators including bromoacetone, phenacyl chloride, phenacyl bromide, and xylyl bromide. Lacrymators and other chemicals sharing the structural element Z=C—C—X, where X=carbon or oxygen, and X=bromide or chloride, urine, endocrine, stomach or faecal extracts or hormones that would have the effect of keeping animals away from a certain area.

### Tags or Markers

To determine if an animal has ingested or digested the projectile, tags or markers can be included. Biomarkers or any substance can be used to assist in determining whether an animal has ingested the contents of a capsule.

Suitable biomarkers or tags added to identify animals that have ingested the active agent include antibiotics such as tetracycline, lophenoxic acid, radioactive isotopes such as rubidium chloride, dyes such as food dye or gentian violet.

The projectile may also contain edible dyes that may be visible in or around the mouth when eaten or released in droppings or urine for later detection.

### Projectile Materials

Biodegradable materials can be used for the projectile shell. The capsule or pellet may last from between 5 minutes (as for use in fish) or up to about 6 months (as for use in possum control).

Projectile integrity can be formulated to allow firing but not cause rupture on impact with ground. The desired integrity will depend on the type of capsule, in some applications the outer capsule is meant to rupture but the internal capsule stays intact. With other applications such as the pellets, a hard coating such as bone meal protects the inner pellets during ingestion.

Shell integrity measurements can be carried out during suitable trials.

Preferred distances to be fired would be in the order of several to hundreds of meters. For fish it could be as little as 2-5 meters but for geese or other timid animals it could be as much as 1000 metres.

### Target Animals

Target animals include wild, domestic, domesticated, farm, feral or pest animals including but not limited to rats, mice, cattle, goats, sheep, camels, raccoons, badgers, deer, antelope, horses, buffalo, geese, pigeons, ducks, fish, dogs, cats, foxes, possums, coyotes, kangaroos, rabbits, bison, pigs, hippopotamus, elephant, hares, snakes, lizards, crocodiles, frogs, spiders, borers, termites, ants, bees, flies.

### Applications

The present invention can be used throughout the world for various applications.

South America—oral vaccines for fish farming and aquaculture.

North America—large scale programmes for the Rabies vaccination of raccoons, skunks and foxes.

United Kingdom—The Eurasian badger (Meles meles) represents a wildlife source of recurrent Mycobacterium bovis infections of cattle in the United Kingdom, and its vaccination against TB with M. bovis bacillus Calmette-Guërin (BCG) is an attractive disease control option.

Asia (India and China specifically): existing programmes for the Rabies vaccination of feral dogs.

Western and Eastern Europe—Rabies vaccination of raccoons

New Zealand: Culling of feral animals such as deer, possums. For example, possums are a wildlife vector of bovine tuberculosis in New Zealand. Vaccination of possums with BCG is being considered as a measure to control the spread of bovine tuberculosis to cattle and deer.

Australia: contraception of kangaroos, culling programmes for feral, dogs, foxes, cats, rabbits.

### Regulatory Issues

There do not appear to be any serious regulatory issues, particularly as there are oral vaccines and poisons currently being used by most governments in wild animal disease control programs and that can be deployed using this technology.

### Uses

The present invention introduces the capability to improve the efficiency and efficacy of delivery of oral treatments to animals in a wide range of situations. Its benefits and application is not limited to, but has specific application, in the field of vaccination of disease carrying wild and feral animal populations. Containment of the treatment substance within an edible and fully biodegradable capsule, and the ability to deliver the baited treatment capsules to optimum habitat locations by remote means, represent a major advance and economic benefit.

Most current treatment methods require immediate proximity to the animal. In contrast, the present invention can provide remote delivery from a safe distance and is the only administration option which avoids capture, sedation or mustering/herding of animals. The incidence of secondary infection from needle site or treatment wound is particularly significant in the case of wild animal species (exposed to the elements) and is a material problem in the industry. Equally, the incidence of injury to animals and handlers when stock such as cattle are mustered, yarded and driven through a crush for individual dipping/treatment application can be a problem.

Prior art remote, projectile based delivery methods which do not deliberately pierce the skin (dart, syringe, silicon implant) are ineffective. The present inventor has developed a system for remote delivery/administration that can effectively treat or kill an animal in a more effective or controlled manner.

The reliable delivery of a full dosage is fundamentally important, particularly with or veterinary pharmaceuticals. Under dosing leads to mutation and rapid resistance build up. In terms of efficacy considerations, any treatment method which ensures delivery of an effective dose will therefore be favoured over those with arbitrary dosage characteristics. The present invention is adaptable for reliable dosage control matched only by injection.

Administration of active agents by food/water additive, sprays etc is notoriously arbitrary. Individual dosage accuracy also has cost and environmental implications. Splash and spillage from dip treatment involves additional ingredient lost to wastage. It is generally unlawful to use or apply a veterinary pharmaceutical agent without regulatory licence or authority. The product and any apparatus used to deliver it must meet the required standards of safety, efficacy and tolerance.

Current art methods of direct treatment can involve impact site injury or skin rupture of a scale unlikely to be acceptable to veterinary practitioners and/or the licensing authorities on both animal welfare and potential for secondary infection grounds. For environmental eradication programs, it can be difficult to position the bait in desired locations due to vegetation or other environmental factors. Current methods of indirect treatment require physically placing baits or other treating materials into the environment which can be time consuming or difficult to treat widely. The ability to fire projectiles accurately and over long distances is a clear advantage of the present invention.

The present invention relates to the treatment of animals, especially wild animals, pest animals or any type of animal which may be free-ranging and not in captivity. Such animals are difficult or cumbersome to capture and treat using conventional methods. Most direct methods for treating wild animals are highly stressful to the animals, and include darting the animals, chasing them into catch-nets or enclosures, or sedating them prior to administering treatment. The prior art methods are also dangerous to the persons administering such treatments, as darts have to be used containing potentially hazardous drugs including highly toxic morphine related drugs such as etorphine hydrochloride, and the risk of needle-stick or injury is high when attempting to dart as many animals as possible. Furthermore, in current methods it is often difficult for the person administering the treatment to determine which animals have been treated and which animals are still to be treated. This is especially difficult when treating the animals from an elevated area or from a helicopter.

The present invention is not limited to wildlife, but also finds application in the treatment of commercial livestock, domestic animals and companion animals. In the case of cattle, use of the invention as described herein considerably lowers the stress levels of the animals, as compared to conventional dipping or inoculation techniques and reduces treatment process costs.

Typically, projectiles are made from a substance such as, but not limited to, hydrophilic colloidal materials such as, gelatin, silicon dioxide, albumin, gum arabic, alginate, casein, agar or pectins, or combinations thereof. The projectile can also be made from a synthetic organic compound such as, but not limited to, polystyrene, polypropylene, polyethylene, polycarbonate, polyamide, polysulfane, polyvinylchloride, resinous compounds such as fibreglass or Perspex derivatives, or combinations thereof.

The projectile includes an active agent, and optionally an attractant or repellent, a tag or marker. The active agent can be encapsulated in a controlled-release coating prior to inclusion in the projectile thereby allowing the controlled release of the active agent within an animal to be treated animal, once it has passed into the stomach, gut or rumen of the animal. The controlled-release coating may be selected from controlled release compositions known in the field.

Although it is within the contemplation of the invention that internally administrable active agents may also be included within the projectile, the invention is especially suited to delivering oral agents for the treatment of infectious diseases to animals. The treatments may, accordingly, be absorbed by the gut for example and distributed through the blood or lymphatic system of an animal, once it has been eaten by an animal.

The projectile may also include a pharmaceutically acceptable tag or marker composition. The tag or marker is released into the animal of an animal when the projectile is ingested. The tag or marker may be detected in the animal or maybe excreted and detectable in droppings or urine, for example.

The active agent or agents contained in the projectile can be in different forms and/or concentrations, depending on the formulation, the carrying capacity, and solubility and release characteristics desired, for example as neutral molecules, components of molecular complexes, and pharmaceutically acceptable salts, free acids or bases, or quaternary salts thereof. Simple derivatives of the active agents mentioned herein, such as pharmaceutically acceptable ethers, esters, amides and the like which have desirable retention and release characteristics in vivo, and enzymes, pro-active forms, pro-drugs and the like, can also be employed as required.

The amount of active agent will vary depending on the particular active agent, the desired biological effect, and the time span for which the active agent is to be therapeutically effective. Normally, the amount of active agent can vary from about 0.1% to about 50%, or even from about 0.1% to about 30% by weight based on the dry weight of the total carrier composition. Persons skilled in the field of the invention will be able to determine the adequate amounts required for each application, as required. For examples, for lower dose concentrations, such as with steroidal hormones or corticosteroids, the preferred amount need only be from about 0.1% to about 10%.

It is to be appreciated that the order of steps, the amounts of the ingredients, and the amount and time of mixing may be important process variables which will depend on the specific polymers, marking dyes, active agents, solvents and/or co-solvents, enhancers, additives and/or excipients used in the composition.

The examples provided herein are not to be interpreted as being an exhaustive list of possible integers or embodiments of the invention, and serve merely to illustrate the invention.

The system may include a projectile launcher in the form of an air launcher to be used in combination with the projectile of the invention in treating animals. The projectile launcher can include a magazine or reservoir for accepting a plurality of projectiles. Administering a desired active agent to a target animal is accomplished by a person or user aiming the launcher containing one or more projectiles at the animal, and launching a projectile at the animal with a velocity sufficient to rupture the projectile upon impact with the animal. This allows the contents of the projectile to be splattered onto the skin of the animal, allowing the active agent to be absorbed through the skin of the animal via the transdermal carrier.

Any impact on the ground or water of a projectile designed to be eaten by an animal should not result in rupturing.

While the projectile of the invention need not be compartmentalized in order to separate the active agent and other ingredients or contents, it is within the contemplation of the invention that the projectile includes one or more interstitial compartments so as to keep one or more of the components of the projectile from one or more of the other components and only allowing them to mix upon consumption by the animal. For example, the active agent may be formed by the mixing or contact between several agents that are separated in the projectile until eaten.

The projectiles may have sufficient volume to contain a unit dosage for a certain disease for an animal. The dosage is typically calculated to correspond to a certain minimum weight of animal to which an active agent is to be administered. If larger animals need to be treated, the number of projectiles provided to the animal may be increased accordingly. Alternatively, a single projectile dosage for all animal weights may be preserved by alteration of the formulation concentration of the active agent.

For example, in order to treat a young impala weighing, say, 50 kg, a single projectile containing a unit dosage may be enough. However, in order to provide a sufficiently efficacious dose to a larger impala estimated to weigh, say, 100 kg, two or more projectiles may be required.

The launcher can have a selector button which allows one to pre-select the number of projectiles to be launched at the single pull of a trigger of the launcher, thereby allowing larger animals to be treated with the correct dose required, merely by selecting the number of projectiles to be launched simultaneously. This has the advantage that the animal does not have a chance to escape following the first firing of the launcher, as the projectiles reach it substantially simultaneously. Launching one projectile at a time may result in the animal fleeing, making it difficult to track down the same animal and administer a second (or different) dose.

Similarly, it may be necessary to treat an animal with a combination of active agents. This may be accomplished by using a projectile having contained therein a combination of active agents. It may not always be possible to produce a projectile having two or more different active agents therein, due to adverse reactions occurring between such active agents when they are co-mixed. However, in some instances it may not be feasible to produce a single projectile large enough to accommodate the required unitary doses of two or more active agents.

Alternatively, a user may elect to launch two or more projectiles each containing a different active agent or different set of active agents individually to the animal.

The launcher may be loaded with projectiles in a pre-determined series which may be discharged substantially simultaneously, one may elect to load, say, a projectile containing one active agent, another projectile containing a different active agent and a third projectile containing a health supplement, pre-set the launch to launch three projectiles, and accordingly treat an animal with the three different active agents, substantially simultaneously.

It follows thus that a user may elect to load the launcher with several series of such projectiles, following which each time the launcher is aimed at an animal and the trigger is pulled, a selected series of projectiles is discharged.

The invention extends thus to a method of loading a launcher with the projectiles of the invention, by loading a plurality of such series of projectiles, each containing a unit dosage of an active agent, which may be the same, or different.

### EXAMPLES

### Projectile

### Preparation of the Gelatine Base

The ingredients for projectile base were:

water, glycerine and/or sorbitol, and gelatine.

The glycerine and water were weighed in a suitable tank, temperature regulated at about 65° C.

The gelatine was weighed in a separate tank.

The melting apparatus was under vacuum to load the glycerine and water solution, then the vacuum was stopped and the solution was slowly mixed, heating at 80-85° C.

The gelatine was added under vacuum, keeping the blade stirrer at maximum speed. After 5 minutes of mixing, the vacuum was maintained to remove the air from the projectile base. The vacuum was stopped when there were no air bubbles in the projectile base.

The projectile base was ready to discharge in the gelatine tanks heated at 60° C., applying a pressure with the nitrogen.

### Preparation of the Fill

The contents of the projectile was either a solution or suspension.

Solution—The pre-weighed active agent, additives and dissolving liquids are put into a stainless steel “Vessel” and stirred until dissolution was completed. Vacuum was applied. The solution was typically at room temperature but preparations can be heated to form the required solution.

Suspension—The suspending agents were weighted into an heated tank, and stirred during the addition of fats and waxes, that are added from a separate tank where they are kept molten.

To the homogeneous liquid phase are added the powdered ingredients, adding first the more lighter components to avoid a rapid sedimentation.

The mixture was passed through a colloid mill to homogenise the system, and to reduce the particle size of raw materials. Then, the prepared suspension was de-aired by the vacuum, because the presence of air can cause dosage variation at the filling site, since the dosing pump delivers a constant volume.

The material was then transferred to a tank.

### Projectile Manufacture and Filling

The soft gelatine projectile was filled with the composition to form the projectile. This was achieved by feeding two ribbons of gelatine between two die-rolls, into the nip of which the liquid contents of the projectile are fed.

Matching pockets on the rolls allow the fill to distend the gelatine ribbon and mould it to a fixed shape. Simultaneously the edges of the formed projectile are welded together.

The gelatine ribbon is formed in the body of the machine itself. Projectile base from the supply tank flows down by gravity through a clean-line pump and heated tubes to a spreader box. The spreader boxes sit upon a rotating casting drum. The back face of the spreader box (gate) can be raised by a pair of screws so that the width of the slot at the gate of the box, through which the gelatine passes, can be increased or decreased. It is possible to maintain a uniform machine output by'changing the film thickness to compensate the changes of the gelatine.

The gelatine structure can be modified:

by temperature

by age

by viscosity

by elasticity (bloom)

The projectile base, when spread onto the casting drums, travels round the periphery over a period of about a minute, cooling and setting as it goes. The drums are cooled by a flow of air coming from the cooling system situated on the back of the machine.

The ribbon is then picked off by a roller and passes between a pair of lubrication rollers, that give the lubrication with a vegetable oil (MIGLYOL) to both sides of the ribbon. Now the two ribbons are ready for the passage through the filling section of the machine.

Two such ribbons are formed at the same time, and pass over the feeder rolls onto the pockets of the die-rolls. As the opposing cavities come towards one another, a unit dose of the contents is injected by one stroke of a double-acting piston pump. The contents reach the cavities through holes drilled in a metal block, the injection segment, which rides under its own weight on the gelatine ribbons entering to the pockets.

The segment surfaces are curved to conform to the roll configuration. As the gelatine ribbon passes the segment, it receives the liquid, deforming into the cavities to accept it.

The edges of the projectile are then sealed, welded evenly by the roll pressure and are cut off all around as the projectile passes between the narrowest part of the inter-roll gap. Below the rolls, the projectiles fall freely into twin belt conveyors, whilst the net continues to travel vertically downwards.

### Drying Process

The drying of the projectiles is divided in two phases:

in a tumble dryer

in a drying tunnel.

The first phase, which occurs in the tumble dryers, is the relatively rapid removal of the water that is going to be removed.

The rate-limiting factors are mainly:

the boundary layer in the air film surrounding the projectiles, which can be reduced in thickness by increasing the ventilating air rate;

the second is depending of the rate at which water can diffuse through the gelatine of the projectile, and this is a function of:

temperature

amount of plasticiser in the gelatine

nature of the fill.

The projectiles are finish-dried therefore in a drying tunnel, where air is supplied at a relative humidity of below about 20%, and a temperature of about 22 to 24° C.

Normally the projectiles are held for about 2 to 5 days in such an environment to reduce the moisture content of the gelatine to about 6 to 12%.

For projectile contents containing water-soluble vehicles, the drying time is usually extended because the contents may have adsorbed water from the shell and will release it only slowly.

The rate of drying is typically matched to the slowest diffusion rate-process in the system, otherwise the projectile may fail during drying, or will re-equilibrate on storage.

### Inspection

After the final drying, ideally every projectile should undergo inspection.

The principal defects are selected from critical defects (foreign projectiles, leaking projectiles, under or over weight projectiles) and major & minor defects (mis-shapes, air bubbles, colour and clarity, greasiness, twins).

A first inspection can be carried out on the drying trays, where the leaking projectiles are easily removed and where possible to check for the other defects.

A second Inspection can also be carried out automatically by means of a riddling machine (PHARMASORT 6-12, for example). Automatic inspection, however, will only eliminate projectiles being under or over weight, twins or mis-shaped.

### Packaging

Normally projectiles made by the manufacturer are packed in standard bulk packs, the number of projectiles per pack depending upon the size of the projectile. The projectiles can be counted by either electronic or weight counters. The electronic counter, while giving precise count (deviation less than 0.2%), tends to be very slow. The weight counter has a speed of more than 500,000 projectiles/hours. The projectiles are then put into standard 0.125 mm polythene bags and heat sealed, and then packed in corrugated cardboard cartons, which are placed on pallets.

This package will protect the projectiles for between three and six months from excessive moisture pick up, if stored under normal warehouse conditions.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1.-19. (canceled)

20. An oral delivery system for remotely treating an animal, the system comprising:
an edible dosage projectile capable of being remotely delivered over a distance, the dosage projectile containing an active agent selected from the group consisting of oral veterinary pharmacological, oral contraceptive, hormone, health supplement, oral vaccine, immunogenic compound, immunogenic composition, poison, and toxin;
wherein the dosage projectile is configured to contain the active agent until consumed by an animal and configured not to rupture after remote delivery and prior to consumption by an animal.

21. The system according to claim 20 further including an attractant.

22. The system according to claim 20 further including a tag or marker.

23. The system according to claim 20 further including a repellent.

24. The system according to claim 20 further including food material.

25. The system according to claim 20 wherein the dosage projectile comprises a shell and the active agent is housed within the shell of the dosage projectile.

26. The system according to claim 20 wherein the dosage projectile is in the form of a capsule or pellet produced in circular or spherical form having a diameter from 2 mm to 50 mm.

27. The system according to claim 26 wherein the dosage projectile has a volume of about 10 ml.

28. The system according to claim 20 wherein the dosage projectile has an outer shell formed of gelatine, linear polymers, polystyrene derivatives, thin-walled plastics materials, hydrophilic colloidal materials silicon dioxide, albumin, gum arabic, alginate, casein, agar, pectins, synthetic organic compounds, polystyrene, polypropylene, polyethylene, polycarbonate, polyamide, polysulfane, polyvinylchloride, 30 resinous compounds, fibreglass, Perspex derivatives, or combinations thereof.

29. The system according to claim 28 wherein the outer shell of the dosage projectile is made of soft gelatine, glycerol, sorbitol or combinations thereof.

30. The system according to claim 20 wherein the active agent and optional contents are encapsulated in one or more encapsulating or coating agents in order to control delivery of the active agent to the animal when the dosage projectile is consumed.

31. The system according claim 20 wherein the active agent is a vaccine.

32. The system according to claim 31 wherein the active agent is a rabies vaccine.

33. A method for administering an active agent to an animal, the method comprising: providing an oral delivery system according claim 20 by remote delivery without rupture of the edible dosage projectile; and allowing an animal to consume the dosage projectile to administer the active agent to the animal.

34. The method according to claim 33 wherein the animal is wild, domestic, domesticated, farmed, feral or pest.

35. The method according to claim 34 wherein the animal is selected from the group consisting of rats, mice, cattle, goats, sheep, camels, raccoons, badgers, deer, antelope, horses, buffalo, geese, pigeons, ducks, fish, dogs, cats, foxes, possums, coyotes, felines, kangaroos, rabbits, rats, mice, bison, pigs, hippopotamus, elephant, hares, snakes, lizards, crocodiles, and frogs.

36. The method according claim 33 wherein the active agent treats or prevents an infectious disease, parasite infestation or condition, dietary deficiency, or fertility of the animal.

37. The method according claim 33 wherein the active agent kills the animal.

38. The method according claim 33 wherein the dosage projectile is delivered remotely by a launching device.

39. The method according to claim 38 wherein the launching device is pressure or gas activated to launch the dosage projectile.
